(19) United States
(12) Patent Application Publication
(10) Pub. No.: US 2004/0154277 A1
(43) Pub. Date: Aug. 12, 2004

(54) Trimmer and edger attachment for riding mowers

(76) Inventor: Clyde Daniel Shumate, Draper, VA (US)

Correspondence Address: CLYDE D. SHUMATE, 2764 KIRBY RD., DRAPER, VA, 24324, US

(21) Appl. No.: 10/717,075

(22) Filed: Nov. 19, 2003

Related U.S. Application Data
(60) Provisional application No. 60/428,142, filed on Nov. 21, 2002.

(51) Int. Cl. A01D 34/00

(52) U.S. Cl. 56/12.7

(57) ABSTRACT

A trimming and edging attachment for all types of riding mowers and garden tractors used for residential and commercial needs. The attachment consist of a mounting plate to mount to the front of the mower with three sections of arms extending outward to the left of said mower and just ahead of the left front wheel. The trim head is powered from an engage mechanism with a drive belt off of the main shaft of the mower motor. The power of the pneumatic cylinders that operate the up and down motion of the arms comes from a twelve volt dc motor and pump combination. This pump is an on demand pump and only operates when some type of adjustment or movement is needed. This unit does not depend on the mowing deck to be in operation while using the trim and edge attachment.

### BACKGROUND OF THE INVENTION

In years past and on the market today are the hand held, two cycle engine powered grass trimmer and edger. These units are all that is available to the public for doing the task of trimming and edging around the yard, driveways and sidewalks.

With all of the know problems and troubles that are present when using any of these units it would seem to be a need for change. For example, mixing gas and oil, pulling a cord to start the machines, storage of gas and oil, short life of machines due to the cheap nature of the units on the market today, costly repairs and the awesome job of carrying the machines strapped around your shoulder

I feel that all of this plus the fact that they are not very ergonomically friendly gives reason for the public to be dissatisfied with hand held trimmers and edgers in general. Even when you look back and compare them to the very old way of trimming, you can see that they have been good at one time in our market but now have out lived their time and the public deserves a new way of edging and trimming.

When using the existing machines that are present on the market place today you can also see the low grade of workmanship and the fact that you probably want be using this machine very long due to the fact that it simply want last. When this happens you will throw away the old one and have to buy a new one. In fact the manufactures are now starting to call the units throw away machines.

Even in the best of times the products now on the market will not give you a smooth and clean cut due to the fact of how they are used, which is in a swinging motion and cannot be depended upon to give that nice clean and well groomed look everyone wants. You either get a high trim or a scalped trim, both of which are not the final look the house hold owner wants.

I cannot say and have not heard anyone say that they love the hand held trimmers and edgers that now have the market, but given the fact that nothing has been presented for the consumer to choose from for so many years, it is simply time to give the homeowners a choice that makes since and will give them a feel of having a real trimmer and edger that meets the demands of today's world.

### SUMMARY OF THE INVENTION

The invention is for an attachment that mounts to the front of riding mowers of all types and styles used for residential and commercial needs. The attachment consists of three sections of arms mounted to the mounting plate that is in turn mounted to the front frame of the mower and extending out to the left and just ahead of the left front wheel.

This unit has two power sources, one is powered from a belt drive off of the main motor shaft, with an engage and disengage mechanism to allow for starting and stopping of the flex drive shaft that in turn rotates the trim head, the other power source comes from a twelve volt pneumatic motor and pump combination that is powered on demand from a set of pneumatic/electric switch valves, that in turn gets it's power from the existing mower battery.

When there is a need to move or adjust the arms you would push or pull one of the switch valves and depending on what direction you desire it would then start the pneumatic pump and move in that direction.

To start using the unit you would lower the arm downward to near the position of trimming or edging by means of using the correct switch valve, you would then engage the trim head by pulling the engage mechanism linkage and the trim head would start rotating, at this time you would then put the unit in it's final position to do the task needed.

While the unit is operating and being used you can make any and all adjustments from the seat of the mower by using the pneumatic/electric switch valves by choosing the correct valve and then push or pull that valve to make said adjustment. While doing a task with this invention you will need to make simple adjustment from time to time or to go from one task to another it may require the operator to lift the unit all the way up and move to another job and then lower the unit to the next working position. All of this can be done by two switch valves and one engage/disengage mechanism and from the seat of the mower.

This unit also allows for quick disconnect and reconnect by means of one mounting pin, disconnecting one end of the flex drive cable and four slip connect hose fittings. The unit then can be stored and put back on with very labor needed.

When the trim or edge attachment is not in use, the operator may still want to use the mower and because the mowing deck and the attachment do not have to be on at the same time the operator would then by using the correct pneumatic valves raise the support arm in an upward direction and then tilt backwards the head arm, this will put the unit in a home position and clear of any obstacles.

### BRIEF DESCRIPTION OF THE INVENTION

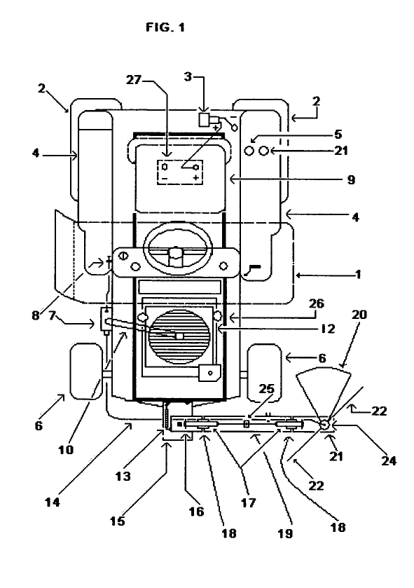

FIG. 1 is a top view showing the trimming and edging attachment mounted to the left front of a tractor style mower, the tractor shown being of the type having a centrally mounted cutting deck. However this invention includes this type of mower but not limited to this style of mower.

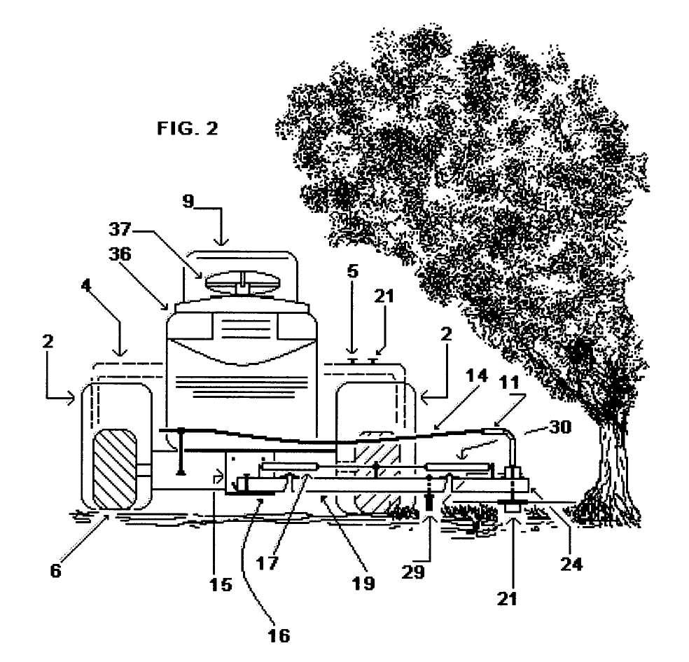

FIG. 2 is a front view of the attachment trimming on level plain under a medium sized shrub or bush where the operator cannot ride under.

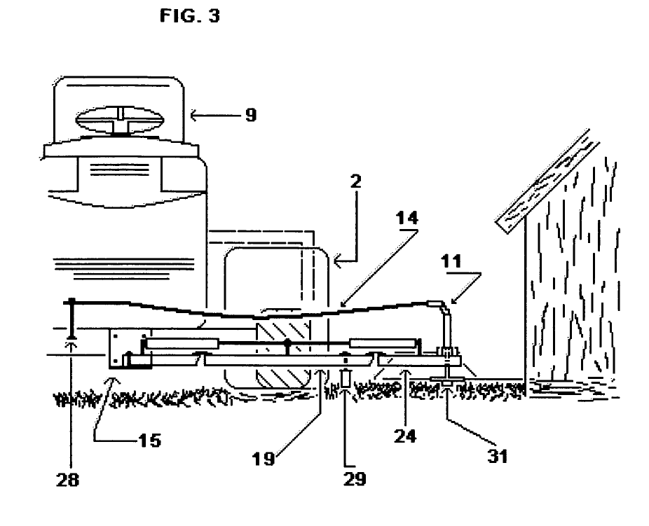

FIG. 3 is showing trimming on a level plain around the types of outside buildings, such as dog houses, play houses and storage buildings that may be in someone's yard.

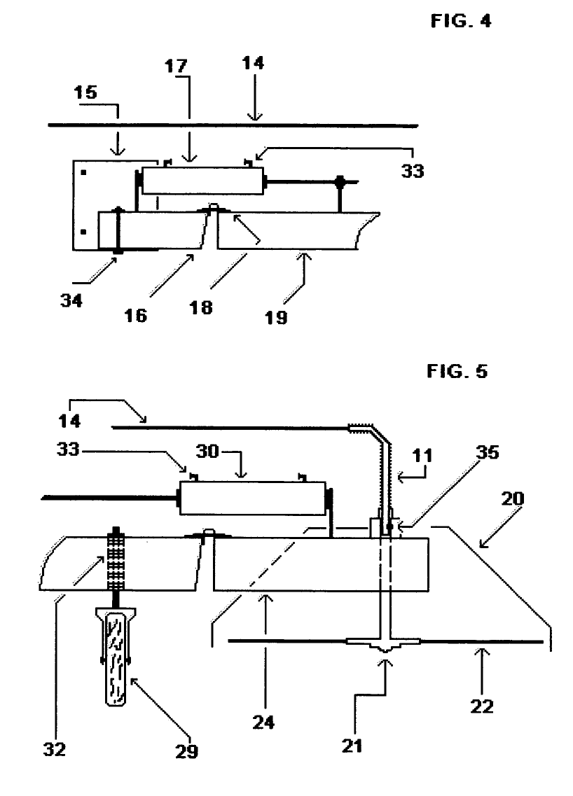

FIG. 4 is showing a plain level, side view of the first half of the unit giving a more detailed look at the parts of the unit

FIG. 5 is showing the second half of the unit which is a continuation of line 4, This is giving a more detailed look at the parts of the unit.

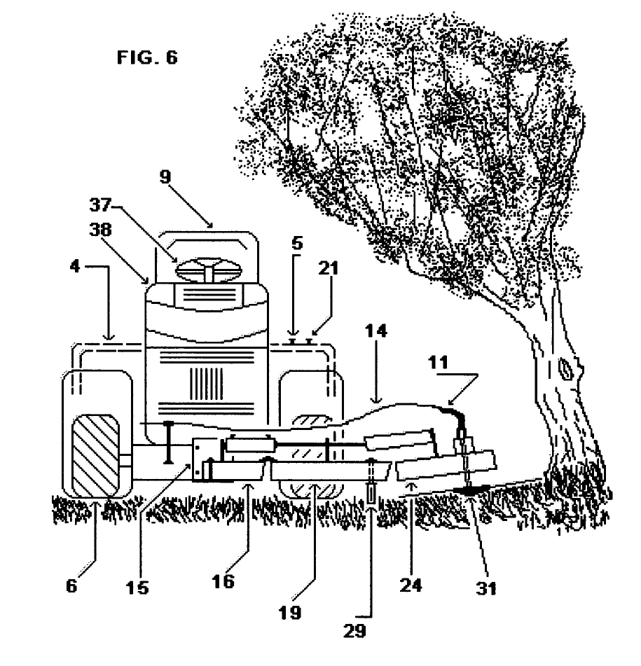

FIG. 6 is a front view with the tractor on a level plain and the trim head on an incline slope, this shows upward adjustment from the operator's controls.

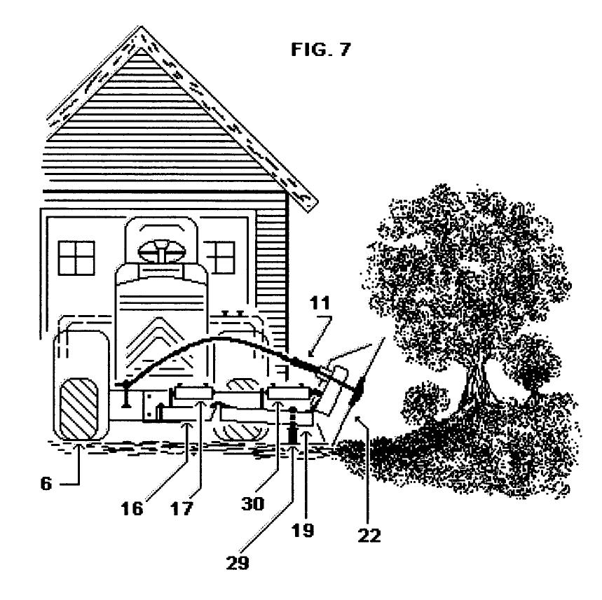

FIG. 7 is an front view showing the tractor on a plain view with the ability to raise the trim head in an upward position as to allow for edging, shown is a drive way but is not limited to that only.

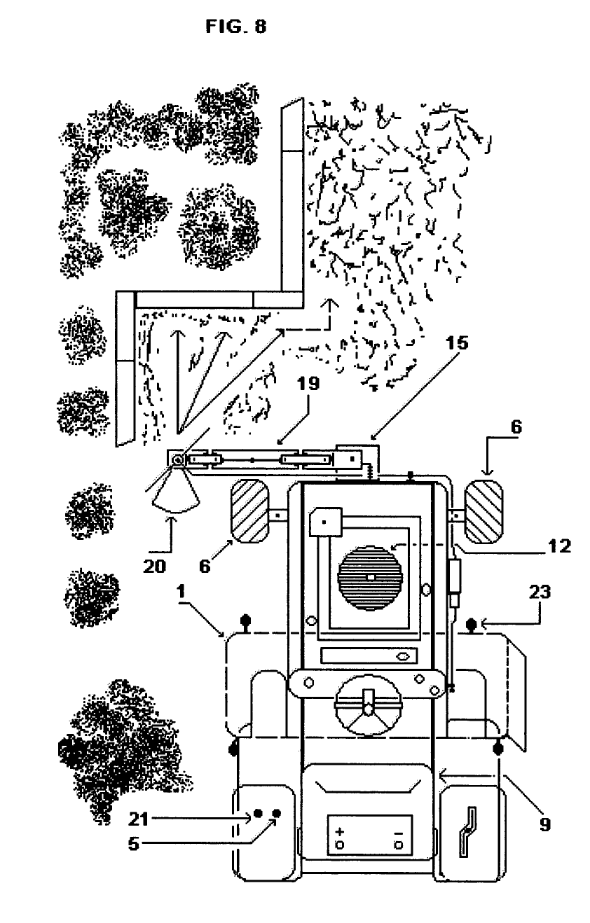

FIG. 8 is showing a top view looking down on an inside corner. This show's how to trim with just a few moves in one of the hardest places in the yard to trim.

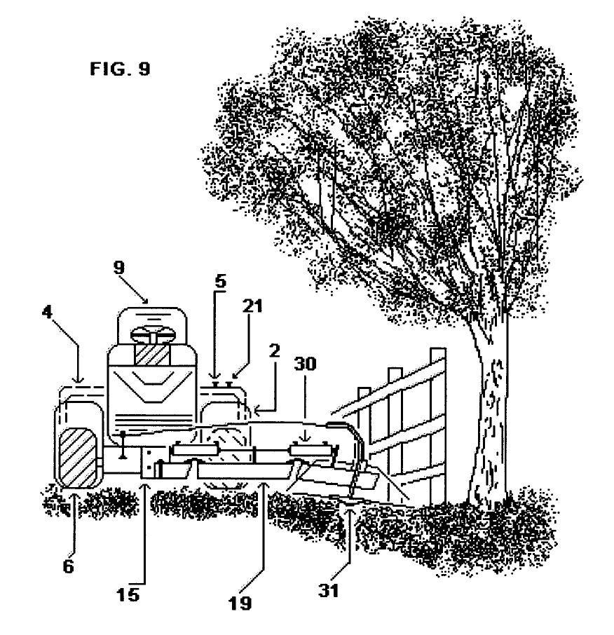

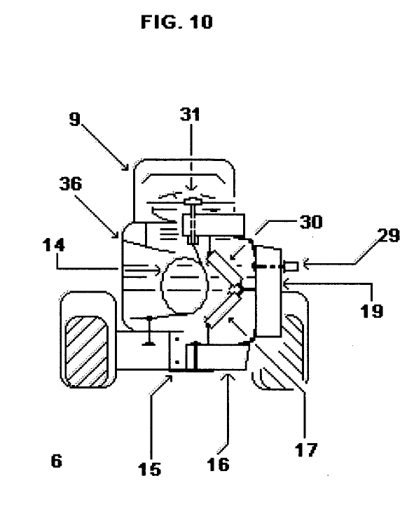

FIG. 9 is showing trimming around the yard with the tractor on a level plain and the trim head in a decline slope, also shown trimming under and around a fence. This show's another adjustment that can be made from the operator while on the seat.

FIG. 10 is showing the invention in an upright or folded back position; this position is used when no trimming or edging is needed and the unit is put in a home position.

### DETAILED DESCRIPTION OF THE INVENTION

Referring to FIGS. 2 thru 10 there is illustrated one of several types of riding mowers and garden tractors 36 this includes and not limited to this style and type. Having a frame 26 mounted on two rear ground engaging wheels 2 and two front ground engaging wheels 6. Depending on the type of mower or garden tractor the front wheels 6 are of the steering type. Also some models can be steered from the rear wheels 2 The frame 26 typically provides a seat 9 for the user or operator and is provided with the necessary controls including the steering wheel 37. Some mowers while having a center mounted deck 1 can have a deck mounted differently depending on the type and style of said mowers.

In the drawings there is illustrated a trim and edge attachment with parts listed within this description and said parts constitute the entire unit. This unit mounts to the front of a riding mower 36 by the mounting plate 15 and holds the mounting arm 16 outward and to the left of the left front wheel 6. This arm is held in place by mounting bolt 34 and at the end of the mounting arm 16 a second support arm 19 can be connected to the mounting arm 16 by means of a hinge 18 and a support arm cylinder 17. After these connections are made, the trim and edge assembly arm 24 can be mounted by a similar method of mounting the hinge 18 and the trim and edge head cylinder 30 to the support arm 19 and the trim head arm 24 as illustrated in FIGS. 4, 5.

After connecting the above parts you can then mount the engage and disengage mechanism 7 to either side of frame 26 by using parts from the standard hardware package contained with the entire unit and the engage and disengage linkage 8 will be mounted on either side of the mower 36 by hardware from the package contained with the entire unit. The contents of said hardware package are of the standard type and are of common use in the market place.

To power the controls of the trim and edge cylinders 17, 30 you must use power from the battery 27 to the pneumatic/electric switches 5 and 21 which in turn will operate the twelve volt electric pneumatic pump 3. The pneumatic pump 3 will only operate when one or the other of the pneumatic electric switches 5 or 21 have been operated in a pull or push direction depending on the operators needs, for example, if the need to operate the trim head cylinder 30 in an upward direction then the operator would pull up on the proper pneumatic switch 5 and the trim head arm 24 would raise up or tilt backward by the trim head cylinder 30, then if the operator would want that same trim head arm 24 to go downward then a push down on pneumatic electric switch 5 would make the trim head cylinder 30 go downward or tilt forward. The control switches 5 and 21 can be mounted in and around the operator's area depending on the needs of the operator, also the electric pump 3 can be mounted in and around the operator's area depending on the operators needs, the drawings only show the location of pneumatic electric switches 5 and 21 for references only and can be changed by the owner as they see fit.

The power source for the trim and edge assembly 31 will be generated by an engage and disengage mechanism 7 that is mounted on either side the frame 26 of the lawn mower 36 and the linkage 8 to operate the engage and disengage mechanism 7 can also be on either side of the mower 36 depending on the needs of the owner when mounting said mechanisms. At this point the drive belt 10 can be put over the shaft of the lawn mower motor 12 and the shaft of the engage and disengage mechanism 7, after mounting the engage and disengage mechanism the flex drive cable 14 is to be put in the hole on the output side of the engage and disengage mechanism shaft 7 and the set screw 35 can be tightened down to the needed tightness.

At this point the cable must be routed around the front of the lawn mower 36 and in the same direction as the mounting arm 16 and support arm 19 and into the trim and edge assembly as shown in FIGS. 1, 4 and 5. While routing the flex drive cable 14 it must be put into the flex drive cable bracket 28, when approaching the output end of the flex drive cable 14 the flex drive support spring 11 must be put around the outer cover of the flex drive cable 14 and pushed up the flex drive cable 14 so when final connections of the flex drive cable 14 is done the flex drive support spring 11 can be put in the proper place.

At this point the flex drive cable 14 must be cut to its proper length, to do so the trim head arm 24 plus the support arm 19 should be in it's most downwardly position, this will allow for the correct cutting of the flex drive cable 14, when cutting the cable the operator or owner must cut the inner core of the flex drive cable 14 to a length that will allow for the core to be put into the trim and edge assembly 31 on the input side of the trim head assembly 31 this will be an inch or more longer than the outer housing of the flex drive cable 14, then tighten the set screw 35 down to a proper setting. Finally the turf wheel 29 can be mounted to the support arm 19 thru the hole provided and then can be ready for use. When the time for removing the unit from the mower the simple disconnect of the air lines using the connectors 33 and removing the mounting bolt 34 and flex drive cable 14 the unit is then free of the mower and can be stored as needed, to replace the unit simply reverse the above steps.

All of the materials used in this invention is manufactured by the industries standards and are made to exact more working load than the invention can or will need, we feel that the rugged terrain of some lawns and lots will not effect the intended use of this invention as long as it is used in places that are safe for riding mowers and garden tractors. This however will change from mower type and style that is being used at any given time.

By using the control switches 5 and 21 along with the ability to randomly pick a setting for the trim and edge unit to be set at, as illustrated in FIGS. 6 , 7 and 9 this allows to trim and edge any place that the owner or operator can safely operate a lawn mower or garden tractor.

By the use of this invention we have changed how someone will approach the need to trim and edge around the home or other places of choice and can do so from an advantage that is better for people of many walks of life. The simplicity of this invention is part of the embodiment and does not change the ability to do the jobs that has been set in the embodiment.

Having thus described the invention in connection with the preferred embodiment thereof, it will be obvious that various revisions and modifications can be made to the preferred embodiment without departing from spirit and scope of the invention. It is my intention, however, that all such revisions and modifications that are obvious to those skilled in the art will be included within the scope of the following claims.

What is claimed is as follows:

1. An attachment for a riding mower and the like having front and rear ground engaging wheels and used for mowing in and around yards and lots or any other places of choice. The operator can use this invention by first mounting the attachment to the front of said mowing equipment and the likes of Upon completion of installation the operator or owner may use the trim and edge unit to go in and around buildings, houses, landscaping, flower bed islands, trees and any other obstacles. By using the controls that operate the trim and edge head and the engage mechanism you may do the job of trimming and edging without getting off of the mower or garden tractor. This allows the operator to go at will and mow and trim or just mow, as the unit does not depend on the mowing deck to be in operation but also allows both the trimmer and the mowing deck to operate together if the operator desires. By using either or both the trimmer and mowing deck the work at hand can be done at the same time and thus the yard or lot work can all be done together and without the disadvantages of having to get another piece of equipment out to do the trimming and edging. The ease of having the controls at your fingertips allows for smooth and accurate trimming and edging of the yard or lot, you can go from one type of a task to a completely different one and hardly miss a step, the turf wheel allows for the arms to be lowered to a working position without having to stop and adjust the arms to allow for any different type of work. When you start the job of doing the yard mowing and trimming it can be accomplished with ease and never leave the seat of the mower. The unit allows for settings from a total of twenty five degrees below a level plain and upwards to a ninety degrees setting and the head will tilt backward for when the unit is not in use.

2. The attachment of claim 1 FIGS. 2, 3 shows the unit can trim in and around medium and small trees, bushes, outside buildings and other landscaping on a level plain, by using the controls needed also shown is the turf wheel to keep from scalping the ground.

3. The attachment of claim 1 FIGS. 4, 5 is a simple blow up of the arm sections. Showing the quick disconnect air fittings, the mounting bolt and the set screw holding the flex drive inner core in place.

4. The attachment of claim 1 FIG. 6 shows the head section in a slight upward tilt. This shows the mower on a level plain and the trimmer on a slight incline.

5. The attachment of claim 1 FIG. 7 shows the attachment tilted upward into an edging position. This also shows some of the many positions that can be achieved by using the controls to move and adjust both cylinders and arms.

6. The attachment of claim 1 FIG. 8 shows an overhead or top view looking down into an inside comer. This shows the ease of trimming an inside comer with this invention. This is a level plain and the trim and edge unit is on said plain. These settings can be done by the use of the pneumatic electric switches from the seat of the mower.

7. The attachment of claim 1 FIG. 9 shows the mower setting on a level plain, the trim and edge head setting on a slight downward tilt, also shown ability to trim under and around fences. Again the adjustments can be made from the seat of the mower.

8. The attachment of claim 1 FIG. 10 shows the unit upright and tilted back out of the way when not in use.
